(19) United States
(12) Patent Application Publication
(10) Pub. No.: US 2017/0136836 A1
(43) Pub. Date: May 18, 2017

(54) EVER-LEVEL ADJUSTABLE BALL HITCH

(71) Applicant: Theodore R. Davis, (US)

(72) Inventor: Theodore R. Davis, Lake Oswego, OR (US)

(21) Appl. No.: 15/345,467

(22) Filed: Nov. 7, 2016

Related U.S. Application Data
(60) Provisional application No. 62/254,624, filed on Nov. 12, 2015.

(51) Int. Cl. B60D 1/46; B60D 1/30; B60D 1/24; B60D 1/06

(52) U.S. Cl. CPC B60D 1/465; B60D 1/065; B60D 1/30; B60D 1/246

(57) ABSTRACT

Disclosed herein are adjustable ball hitches that include driver, such as a motor or manual crank, operatively coupled to a first gear member; a housing member housing one or more gear members, wherein the one or more gear members comprises the first gear member; and a second gear member fixedly coupled to a ball positioning system member, wherein the hitch member comprises a ball portion; and wherein operation of the driver causes the ball portion to move along a vertical axis relative to the housing member without the need to disconnect the trailer from the hitch.

### CROSS-REFERENCE TO RELATED APPLICATION

The application claims the priority benefit of the earlier filing date of U.S. Provisional Application No. 62/254,624, filed Nov. 12, 2015, which is hereby incorporated herein by reference in its entirety.

### TECHNICAL FIELD

Embodiments relate to vehicle towing hitches, and more particularly, to trailer hitches that are vertically adjustable.

### BACKGROUND

Many different types of hitches are available for towing vehicles such as trailers. While some trailer hitches may be permanently affixed to the vehicle, other trailer hitches are demountable and may be removed when not in use. To accommodate various types and sizes of trailers, some hitch assemblies are vertically adjustable. Such a hitch assembly typically includes a vertically elongate tube or plate having a pattern of vertically-aligned holes through which bolts or pins may be inserted to securely fix the hitch assembly at a desired elevation relative to the tongue height of the trailer and the bumper of the tow vehicle. However, these height-adjustable hitch assemblies may not provide a sufficient range of vertical travel, and manual adjustment of the hitch typically is required if the ball height needs to be raised or lowered. This requires the trailer to be disconnected from the tow vehicle, the bolts or pins removed to manually adjust the ball height, the pins or bolts re-inserted, and then the trailer re-connected to the ball.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings. The dashed lines represent internal structures not visible from the exterior of the device.

FIGS. 1A and 1B show two views of an example of a powered adjustable ball hitch, including a perspective view (FIG. 1A) and a top down view (FIG. 1B), in accordance with various embodiments.

FIGS. 2A-2D show four views of an alternate example of a powered adjustable ball hitch having anti-sway attachments/torsion bars, including a top view (FIG. 2A), a perspective view (FIG. 2B), a front view (FIG. 2C), and a side view (FIG. 2D), in accordance with various embodiments.

FIGS. 3A-3C show three views of components of a drive system, including a front view (FIG. 3A), a perspective view (FIG. 3B), and a side view (FIG. 3C), in accordance with various embodiments.

FIGS. 4A-4C show three views of a middle housing member, including a top view (FIG. 4A), a perspective view (FIG. 4B), and a side view (FIG. 3C), in accordance with various embodiments.

FIGS. 5A-5C show three views of a middle housing member with anti-sway/torsion bar cups, including a top view (FIG. 5A), a perspective view (FIG. 5B), and a side view (FIG. 5C), in accordance with various embodiments.

FIGS. 6A-6C show four views of a ball lift system, including a top view (FIG. 6A), a perspective view (FIG. 6B), a front view (FIG. 6C), and a side view (FIG. 6D), in accordance with various embodiments.

FIGS. 7A-7C shows three views of an upper housing, including a top view (FIG. 7A), a perspective view (FIG. 7B), and a side view (FIG. 7C), in accordance with various embodiments.

FIGS. 8A and 8B show two views of a worm gear, in accordance with various embodiments.

FIG. 9 shows a perspective view of a motor, in accordance with various embodiments.

FIG. 10 shows a perspective view of a baseplate, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

Embodiments herein provide adjustable towing hitches that allow for the adjustment of the ball platform, and hence the ball portion, of a trailer hitch without the need to detach the trailer hitch from the ball portion or the ball platform. In various embodiments, the trailer hitch may be automated, such that height of the ball portion may be adjusted, for example using an electric motor or manual crank, and one or more gears. In embodiments, the adjustable ball hitch includes a housing member housing one or more gear members. In embodiments, the one or more gear members include at least a first gear member and a driver operatively coupled to the first gear member. In embodiments the driver or drive member is a motor, such as an electric motor, for example an electric motor powered by electricity supplied from a vehicle, or another power source, such as one or more batteries. In embodiments the drive member is a manual crank, which may act alone or may be coupled to the motor, for example as a manual override. In embodiments, the adjustable ball hitch includes at least a second gear member that is fixedly coupled to a ball lift system, wherein the ball lift system includes a ball portion; and wherein operation of the driver causes the ball lift system to move along a vertical axis relative to the housing member. In embodiments, one or more gear members are a worm gear, for example fixed in vertical position relative to the housing, such as by bearing and/or bushings. In embodiments, the second gear member is a flat gear, for example fixed to the ball lift system. In embodiments, the adjustable ball hitch includes a reduction gear, which, in some embodiments, is fixedly coupled to the worm gear. In some embodiments, the adjustable ball hitch includes a drive gear, for example a drive gear engaged with a reduction gear. As shown in the embodiments illustrated the worm gear is meshed with the flat gear which is coupled to the ball positioning system. Rotation of the worm gear in its vertically fixed position, for example via the driver, drive gear and/or reduction gear, causes the flat gear, and thus the ball positioning system, to move in a vertical direction either up or down. Although particular embodiments depict a worm gear other gear systems, such as ring gears, are contemplated.

In embodiments, the adjustable ball hitch includes a locking mechanism, for example to prevent the ball positioning system from unwanted vertical movement with respect to the housing. For example the housing may include positioning holes that interlace with positioning holes on the ball positioning system to lock there two members with respect to each other, for example using a pin inserted through the positioning holes. Other locking mechanisms are also envisioned, such as a ratcheting mechanism and the like.

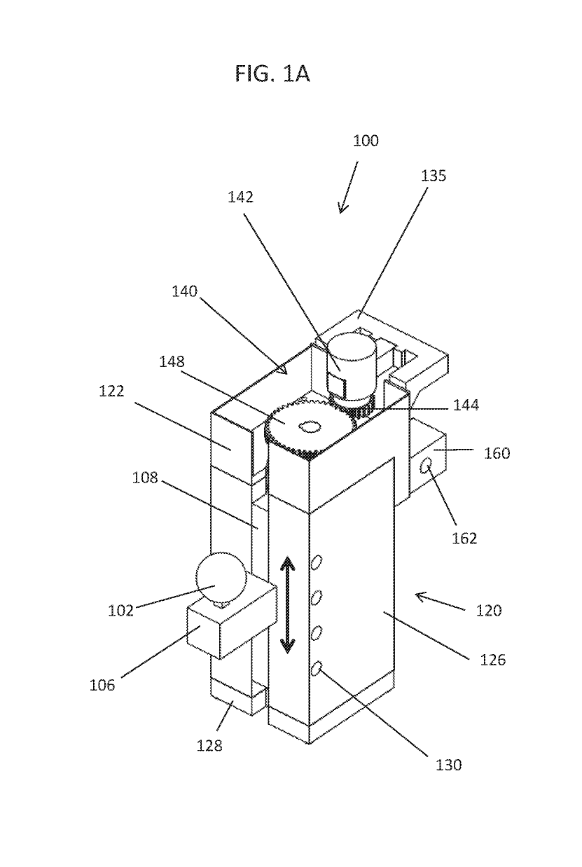

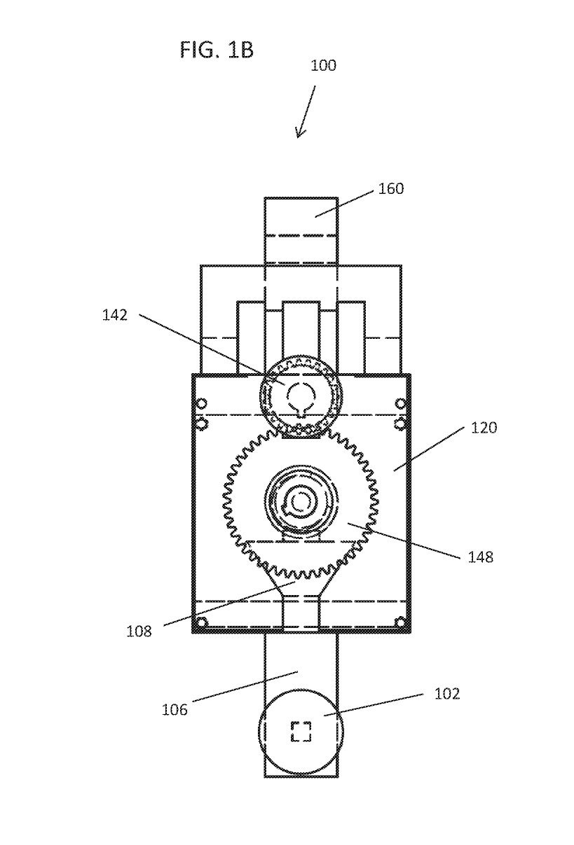

FIGS. 1A and 1B illustrate an example of a powered adjustable ball hitch 100, in in accordance with various embodiments. FIG. 1A illustrates a perspective view of an example of a powered adjustable ball hitch 100, in accordance with various embodiments. FIG. 1B illustrates a top down view of an example of a powered adjustable ball hitch 100, in accordance with various embodiments. As illustrated in FIGS. 1A and 1B, the powered adjustable ball hitch 100 includes a ball portion 102, a housing member 120, and a drive mechanism 140. The ball portion 102 may be adjusted vertically with respect to the housing member 120 by drive mechanism 140 as shown by the double headed arrow. As depicted in the embodiment shown, the housing 120 includes upper housing member 122, middle housing member 126, and housing base plate 128 that are mechanically couple to form the housing 120. It is contemplated that the upper housing member 122, the middle housing member 126, and the housing base plate 128 can be separate pieces or a unitary member, or a combination thereof, for example 1, 2, or more pieces. As shown, middle housing member 126 may include positioning holes 130 that can be used lock the ball portion 102 into place, for example using a pin inserted through the positioning holes 130. Other locking mechanisms are also envisioned. For example, locking mechanisms include ratcheting mechanisms. With a ratcheting mechanism, as the ball portion is raised a pawl or other stop clicks through teeth. To lower the ball portion of the pawl or stop can be moved out the way. Such mechanisms and other stops are known in the art. The upper housing member 122 may include motor locator flange 135. Also shown in this view is ball platform 106, upon which the ball portion 102 is coupled. The ball platform 106 may be coupled to vertical positioning shank 108, which may be adjusted vertically (for example, raised and/or lowered) with respect to a housing member 120 by drive mechanism 140. Components of an example drive mechanism 140 are also shown in this view. For example, drive mechanism 140 may include a motor 142, or, in some examples, a manual crank, which may be coupled to the ball portion 102 through one or more gears, such as drive gear 144 and reduction gear 148. This view also shows the position of hitch attachment shank 160, which in the view shown includes locking hole 162. The hitch attachment shank 160 may be slotted into a convention trailer hitch attachment (not shown) at the end of a vehicle, such a vehicle intended to haul a trailer.

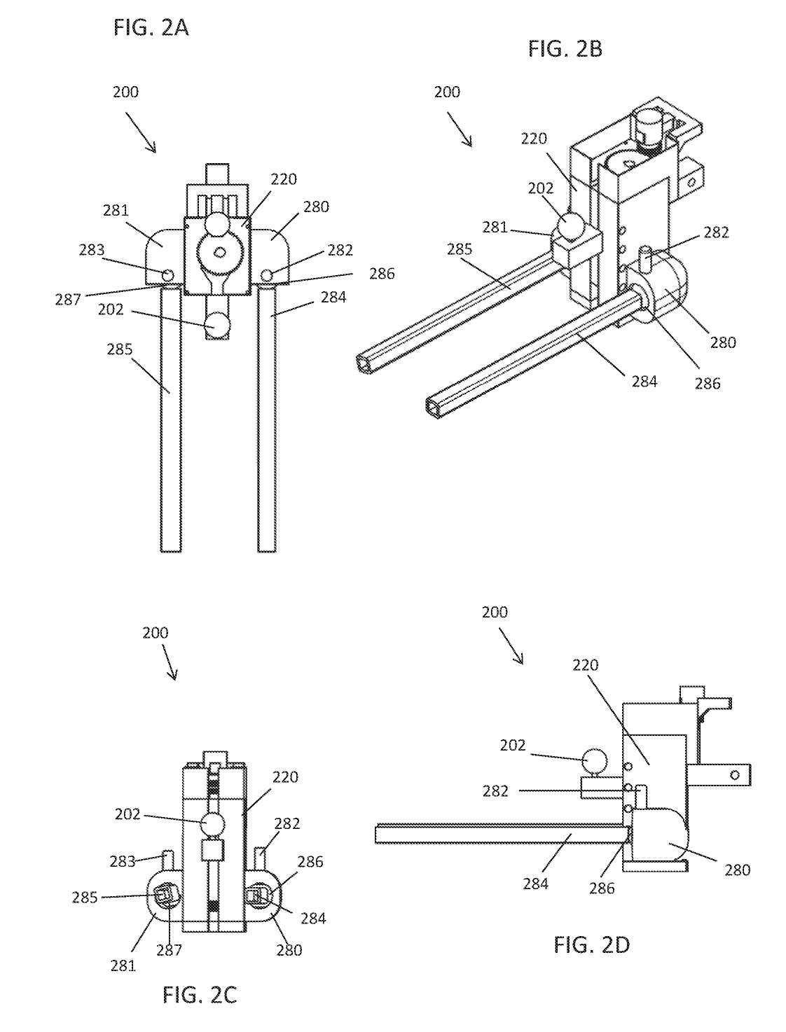

FIGS. 2A, 2B, 2C and 2D illustrate an alternate example of a powered adjustable ball hitch 200 having anti-sway attachments or anti-sway system, in accordance with various embodiments. FIG. 2A illustrates a top down view of an example of a the powered adjustable ball hitch 200, in in accordance with various embodiments. FIG. 2B illustrates a perspective view of an example of a powered adjustable ball hitch 200, in accordance with various embodiments. FIG. 2C illustrates a front view of an example of a powered adjustable ball hitch 200, in accordance with various embodiments. FIG. 2D illustrates a side view of an example of a powered adjustable ball hitch 200, in accordance with various embodiments. Trailer sway can be caused by crosswinds, poor trailer loading (load being too far forward or back), or inadequate spring bar tension in the weight distribution system. To help control sway, a sway-control device as shown in FIGS. 2A-2D may be used. As illustrated in FIGS. 2A-2D, the powered adjustable ball hitch 200 includes a pair of torsion bar cups 280, 281 coupled to a housing member 220 on opposite sides of the housing member 220. As depicted in the embodiment shown, the pair of torsion bar cups 280, 281 may include locating pins 282, 283 that locate torsion bars 284, 285 through their respective coupling to ball ends 286, 287. The locating pins 282, 283 pass through holes in the torsion bar cups 280, 281 and seed into holes within the ball ends 286, 287 (not visible in these views). The locating pins 282, 283 are configured to inhibit the ball ends 286, 287 from rotating thereby inhibiting the rotation of a trailer connected to the powered adjustable ball hitch 200 through both the ball portion 202 and the torsion bars 284, 285. One advantageous aspect of using the adjustable hitch in conjunction with torsion bars is that the adjustability of hitch allows for loading of the torsion bars. For example raising the ball (attached to the trailer) to the highest position, installing the torsion bars while in this positon and subsequently lowering the ball increases tension on the bars due to the bars being connected to a fixed point of the housing member 220 through torsion bar cups 280, 281.

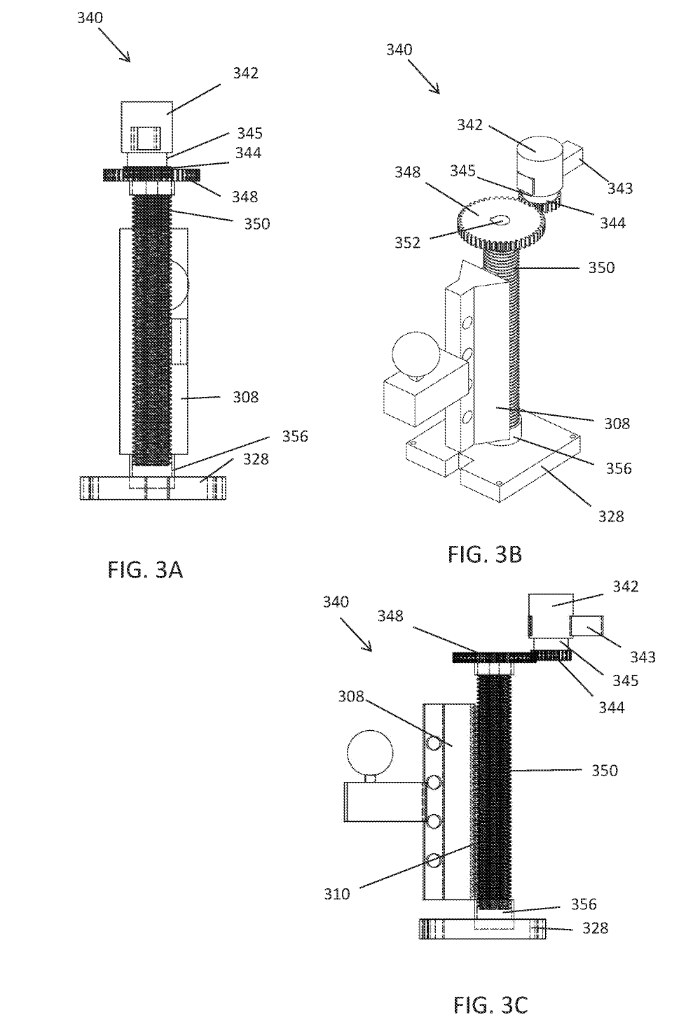

FIGS. 3A, 3B, and 3C illustrate components of a drive system 340, in accordance with various embodiments. FIG. 3A illustrates a front view of an example drive system 340, in in accordance with various embodiments. FIG. 3B illustrates a perspective view of an example drive system 340, in accordance with various embodiments. FIG. 3C illustrates a side view of an example drive system 340, in accordance with various embodiments. As illustrated in FIGS. 3A-3C, drive system 340 may include a motor 342, which may be coupled to a drive gear 344, for example through a motor shaft 345. The drive gear may in turn be engaged with reduction gear 348. The reduction gear 348 may be coupled to a worm gear 350, for example through a keyed shaft 352 at the end of worm gear 350. The worm gear 350 may further be coupled to the vertical positioning shank 308 for example through meshing with a flat gear 310 coupled to the vertical positioning shank 308. In the illustrated embodiment, as the drive gear 344 turns (by supplying power to the electric motor 342), the reduction gear 348 rotates the worm gear 350. In use, the worm gear 350 is in direct contact with the flat gear 310, which is coupled to the vertical positioning shank 308. In the illustrated embodiment, the rotation of the worm gear 350 in its vertically fixed position causes the flat gear 310 to move in a vertical direction either up or down. The rotation of the worm gear 350 vertically displaces the meshed flat gear 310 and thus the vertical positioning shank 308 coupled thereto. Either or both ends of the worm gear 350 may be vertically fixed, for example with a bushing and/or bearing. Also shown in the view is the housing base plate 328 and a bushing 356 coupled thereto.

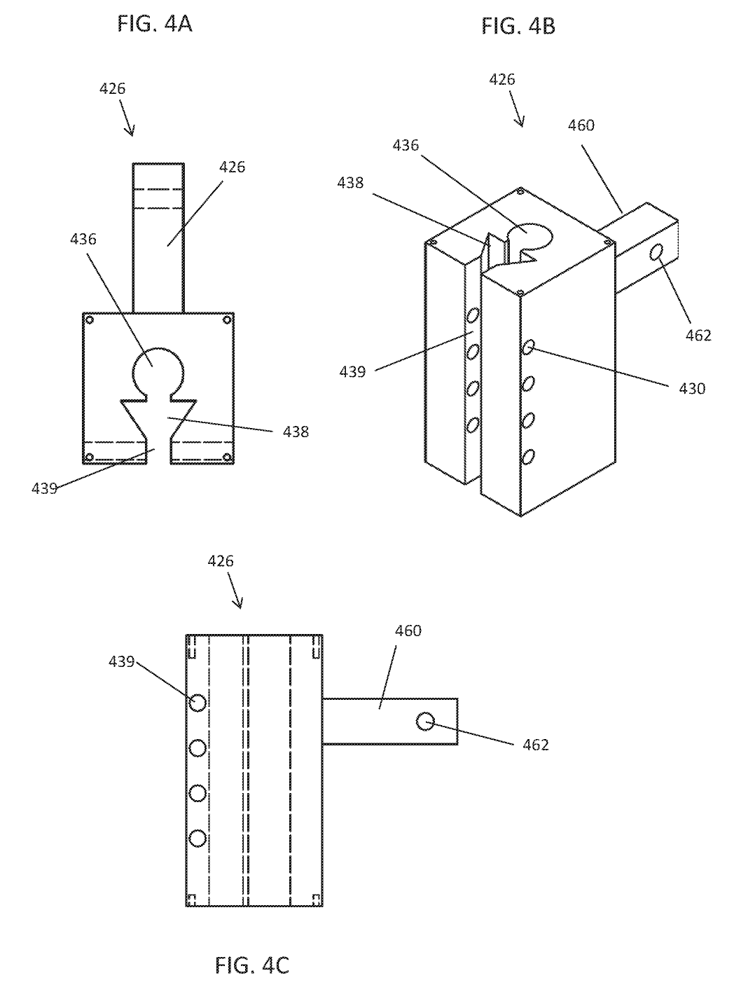

FIG. 4A-4C illustrates views of a middle housing member 426, in accordance with various embodiments. FIG. 4A illustrates a top down view of an example middle housing member 426, in in accordance with various embodiments. FIG. 4B illustrates a perspective view of an example of a middle housing member 426, in accordance with various embodiments. FIG. 4C illustrates a side view of an example of a middle housing member 426, in accordance with various embodiments. As illustrated, the middle housing member 426 includes a vertical chamber 436 for housing the worm gear (see FIG. 3), for example vertically within the chamber the vertical chamber 436. The middle housing member 426 also includes vertical chamber 438 for housing the vertical positioning shank and slot 439, through which the ball platform protrudes (see FIG. 3). While a substantially triangular vertical chamber 438 is shown it is envisioned that other shapes could be utilized, so long as the vertical positioning shank is not pulled through the slot 439. In addition, the middle housing member 426 includes positioning holes 430 that can be used lock the ball portion into place, for example using a pin (other methods, such as ratcheting methods are envisioned to lock the ball height into place). This view also shows the position of hitch attachment shank 460, which in the view shown includes locking hole 462, coupled to the middle housing member 426.

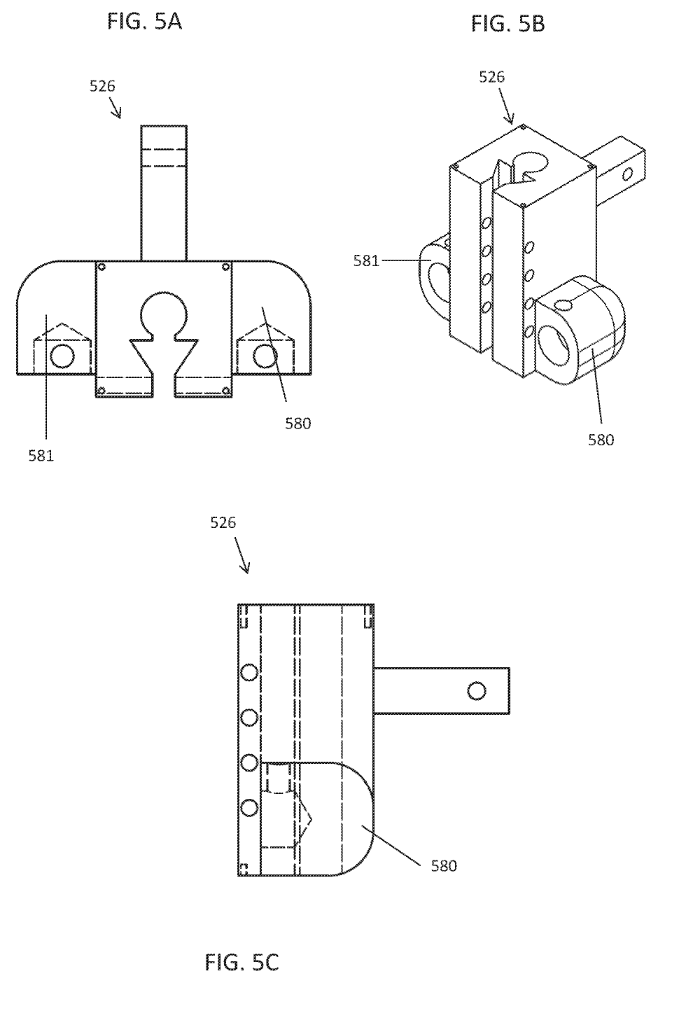

FIGS. 5A-5C illustrates views of a middle housing member 526 including torsion bar cups 580, 581 coupled to the middle housing member 526 on opposite sides of the middle housing member 526, in accordance with various embodiments. FIG. 5A illustrates a top down view of an example middle housing member 526, in accordance with various embodiments. FIG. 5B illustrates a perspective view of an example middle housing member 526, in accordance with various embodiments. FIG. 5C illustrates a side view of an example middle housing member 526, in accordance with various embodiments.

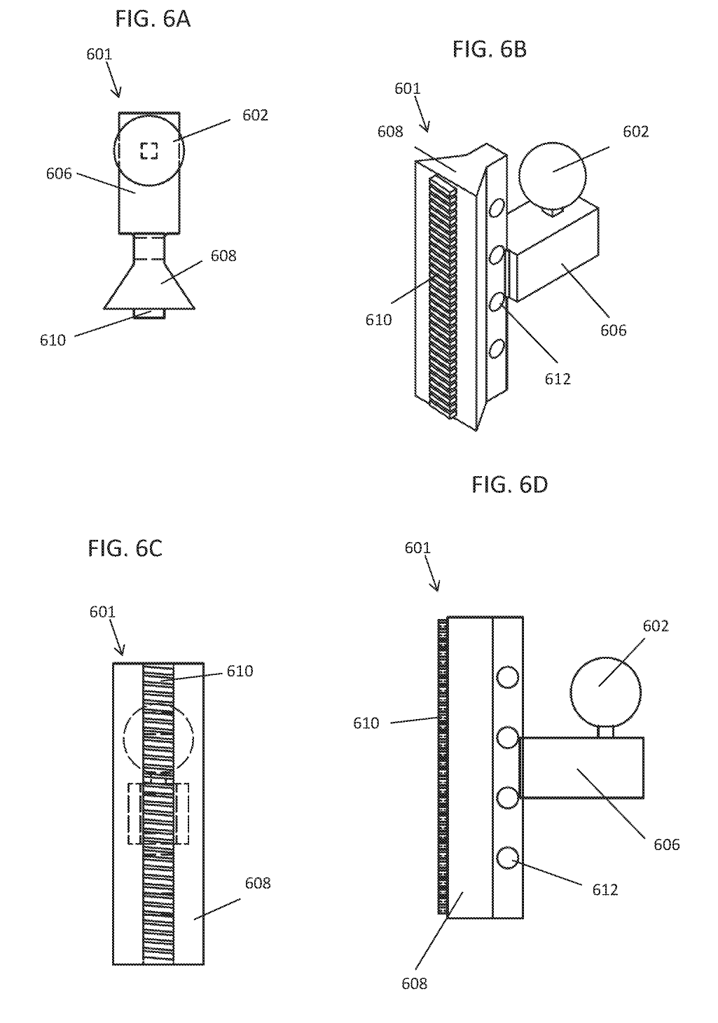

FIGS. 6A-6C are several view of a ball lift system 601, in accordance with various embodiments. FIG. 6A illustrates a top down view of an example ball lift system 601, in in accordance with various embodiments. FIG. 6B illustrates a perspective view of an example ball lift components 601, in accordance with various embodiments. FIG. 6C illustrates a front view of an example ball lift system 601, in accordance with various embodiments. FIG. 6D illustrates a side view of an example ball lift system 601, in accordance with various embodiments. As illustrated the ball lift system 601 includes the ball portion 602, the ball platform 606, the vertical positioning shank 608, and the flat gear 610. The ball portion 602 is coupled to the ball platform either permanently, such as welded, or non-permanently, such as connected with a fastener. The use of a fastener may allow for the use of balls of different diameters or shapes, as desired, adding to the versatility of the system overall. The ball platform 606 is coupled to the vertical positioning shank 608, for example permanently or removably, as described above for the ball. Alternatively, it could be made as a single piece, for example cast and/or machined. The vertical positioning shank 608 is coupled to the flat gear 610 which could be a separate component or cut into the vertical positioning shank 608, such as machined into the face of the vertical positioning shank 608. In the example shown, the vertical positioning shank 608 includes positioning holes 612, which can be aligned with similar holes on the middle housing member (see FIG. 5).

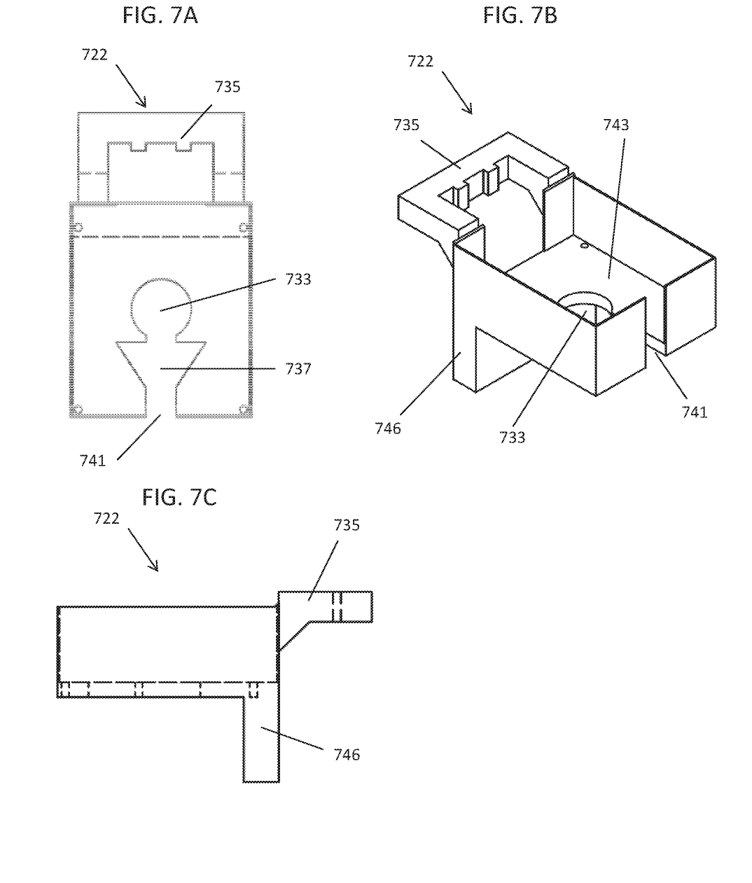

FIGS. 7A-7C are several views of an upper housing 722, in accordance with various embodiments. FIG. 7A illustrates a top down view of an example upper housing 722, in accordance with various embodiments. FIG. 7B illustrates a perspective view of an example upper housing 722, in accordance with various embodiments. FIG. 7C illustrates a side view of an example upper housing 722, in accordance with various embodiments. As illustrated, the upper housing 722 includes a dive system chamber 743 for housing components of a dive system, including a motor, a drive gear, bearing and a reduction gear, see for example FIGS. 3A-3C. In embodiments, the upper housing 722 includes an aperture 733 for the worm gear, or its shaft to pass through such that it can be coupled to a reduction gear or even directly to a motor. In embodiments, the upper housing 722 includes slots 737 and 741 that allow the vertical positioning shank to move relative to the upper housing. In addition, the upper housing 722 includes motor positioning flange 735 that, in embodiments, positions a motor and prevents the motor's rotation with respect to the upper housing 722. In embodiments, the upper housing 722 includes back plate 746.

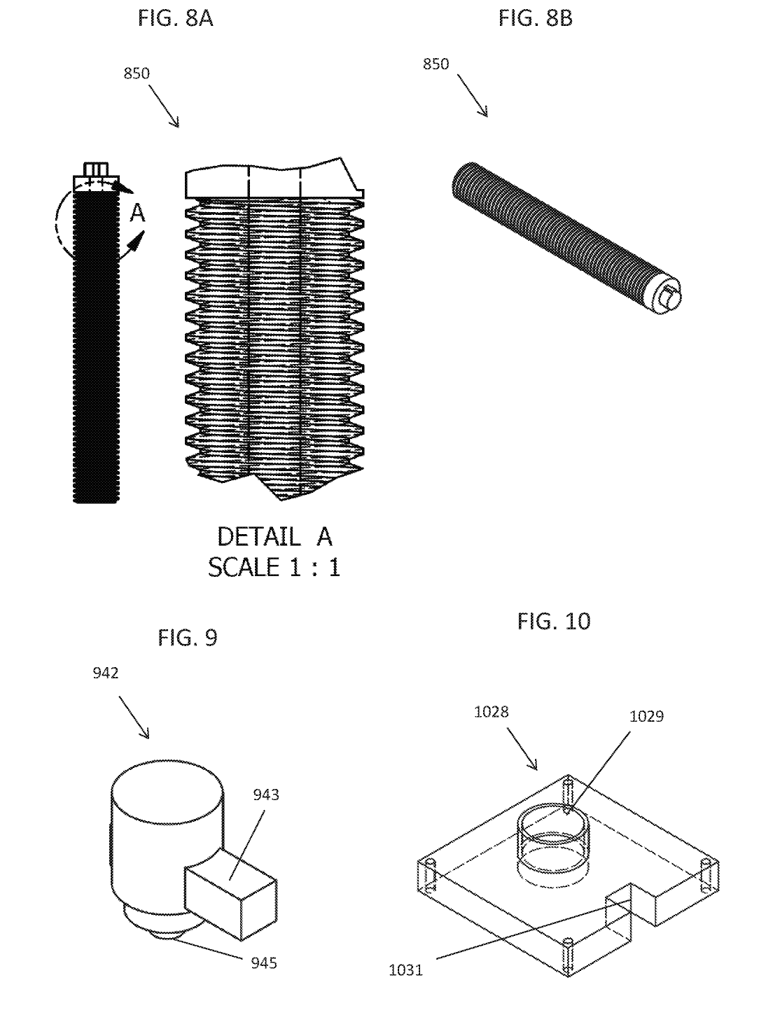

FIGS. 8A-8B are several view of a worm gear 850, in accordance with various embodiments.

FIG. 9 is a perspective view of a motor 942, in accordance with various embodiments. In the embodiment shown, the motor 942 has a motor shaft 945 and a locating shank 943. In embodiments, the locating shank 943 is used to locate the motor 942 in a upper housing and prevent the motor 942 from rotating with respect the upper housing, for example as load is applied a drive gear coupled to the motor shaft 945. In embodiments, the motor shaft 945 is directly, such as fixedly, coupled to a worm gear (not shown). In embodiments, the motor shaft 945 is directly, such as fixedly, coupled to a drive gear (not shown).

FIG. 10 is a perspective view of a baseplate 1028, in accordance with various embodiments. The base plate 1028 includes a worm gear cup 1029 and a notch 1031. In embodiments, the worm gear cup 1029 can be configured as a bushing or a bearing. In embodiments, the notch 1031 is included to allow the ball lift system to slide past the base plate 1028. In embodiments, the base plate 1028 is coupled to a middle housing member, or example with removable or non-removable fasteners. In embodiments, the base plate 1028 is integral with a middle housing member, for example made as a single piece, or made into a single piece, such as welded or otherwise bonded.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. An adjustable ball hitch, comprising:
a housing member housing one or more gear members, wherein the one or more gear members comprises at least a first gear member;
a driver operatively coupled to the first gear member; and
a second gear member fixedly coupled to a ball lift system, wherein the ball lift system comprises a ball portion; and wherein operation of the driver causes the ball lift system to move along a vertical axis relative to the housing member.

2. The adjustable ball hitch of clam 1, wherein the one or more gear members comprises a worm gear.

3. The adjustable ball hitch of claim 1, wherein the second gear member comprises a flat gear.

4. The adjustable ball hitch of claim 1, wherein the driver is an electric motor.

5. The adjustable ball hitch of claim 1, wherein the driver is an manual crank.

6. The adjustable ball hitch of claim 2, wherein the one or more gear members further comprises a reduction gear.

7. The adjustable ball hitch of claim 5, wherein the worm gear is fixedly coupled to a reduction gear.

8. The adjustable ball hitch of claim 7, wherein the first gear member is a drive gear, and wherein the drive gear engages the reduction gear.

9. The adjustable ball hitch of claim 8, wherein driving the reduction gear drives the worm gear.

10. The adjustable ball hitch of claim 9, wherein the worm gear engages the first gear.

11. The adjustable ball hitch of claim 1, wherein the ball lift system further comprises a ball platform coupled to the ball portion.

12. The adjustable ball hitch of claim 1, wherein the ball lift system further comprises a vertical positioning shank.

13. The adjustable ball hitch of claim 12, wherein the vertical positioning shank rides within a chamber of the housing member.

14. The adjustable ball hitch of claim 2, wherein the flat gear is fixedly couple to a vertical positioning shank.

15. The adjustable ball hitch of claim 1, wherein the housing member comprises an upper housing member, a middle housing member and/or a housing base plate.

16. The adjustable ball hitch of claim 2, wherein the worm gear is vertically fixed with respect to the housing member.

17. The adjustable ball hitch of claim 1, wherein the driver is fixed with respect to the housing member

18. The adjustable ball hitch of claim 1, further comprising vertical positioning holes.

19. The adjustable ball hitch of claim 1, wherein the housing member comprises an upper housing member, a middle housing member and/or a housing base plate.

20. The adjustable ball hitch of claim 1, further comprising an anti-sway system.

21. The adjustable ball hitch of claim 1, further comprising a hitch attachment shank.
